(19) United States
(12) Patent Application Publication
(10) Pub. No.: US 2004/0181665 A1
(43) Pub. Date: Sep. 16, 2004

(54) Trust governance framework

(76) Inventor: Daniel D. Houser, Westerville, OH (US)

Correspondence Address: Daniel H. Golub, 1701 Market Street, Philadelphia, PA, 19103, US

(21) Appl. No.: 10/799,314

(22) Filed: Mar. 12, 2004

Related U.S. Application Data
(60) Provisional application No. 60/459,527, filed on Mar. 31, 2003.
(60) Provisional application No. 60/453,928, filed on Mar. 12, 2003.

(51) Int. Cl. H04L 9/00

(52) U.S. Cl. 713/158

(57) ABSTRACT

Methods for managing business risk include establishing standards and engaging trusted parties to perform due diligence and assessments of business risk against the standards. The results of the assessments are delivered in accordance with a protocol. Trust governance for entities is implemented and trust relationships modeling is performed.

### FIELD OF THE INVENTION

The present invention relates to methods for implementing risk management programs, conveying trust assertions, implementing trust governance, and modeling trust relationships.

### BACKGROUND OF THE INVENTION

Sufficient protocols exist in the prior art for establishing trust in electronic business on the message and transaction levels (e.g., SAML, WS-Security, XML-Dsig, Passport), as well as on the session level (e.g., SSL, TLS, IPsec, PKI). However, methods for establishing trust in business transactions and other business-level relationships are insufficient or non-existent. Prior art methods for addressing the establishment of trust involve manual, expensive assessments and lack interoperable standards.

### SUMMARY OF THE INVENTION

The present invention is directed to a method for implementing a risk management program. One or more checklist items that measure risk factors are established. One or more procedures for determining compliance with the checklist items are also established. One or more trusted parties that assess entities against the checklist items using the procedures are certified. The trusted parties perform an assessment of each of the entities based on the checklist items using the procedures and, based on the assessment, dispense a machine readable trust assertion comprising one or more attributes relating to a result of the assessment and/or revoke a previously-issued trust assertion comprising one or more attributes relating to a result of a previously-performed assessment.

The present invention is further directed to a method for conveying an assessment of an entity. A machine-readable trust assertion, issued by a trusted party resulting from an assessment of an entity, is received from the entity. The assessment is based on one or more checklist items that measure risk factors and one or more procedures for determining compliance with the checklist items. The trust assertion is analyzed to determine an identity of the trusted party, checklist items used in the assessment, a score of the assessment, a scope of the assessment, and a date of the assessment. The identity of the trusted party, the checklist items used in the assessment, the score, the scope and the date are compared to an acceptable trusted party identity, acceptable checklist items, an acceptable score, an acceptable scope and an acceptable date. Trustworthiness of the entity is determined based on the comparison.

The present invention is also directed to a method for implementing trust governance for an entity. One or more templates are established. The templates relate to trustworthiness requirements for the entity, based on at least one of an entity policy, any exceptions to the policy and any rules restricting or enabling variances to the policy; and a contractual obligation of the entity. A trust assertion is received in connection with a trust relationship between two or more entities. The trust assertion is issued by a trusted party resulting from an assessment of one of the entities and comprises components of making a trust decision. The components of making the trust decision include an identity of the trusted party; one or more checklist items that measure risk factors used in the assessment; a score of the assessment; a scope of the assessment; and/or a date of the assessment. One or more of the templates to apply to the trust assertion are identified. The trust assertion is compared to the identified templates. A result is determined based on the comparison. The result comprises at least one of an acceptance, a rejection and a processing status message.

Additionally, the present invention is directed to a method for modeling trust relationships. One or more trust assertions for an entity are collected. The trust assertions relate to a trust relationship between the entity and one or more other entities. Each of the trust assertions is issued by a trusted party resulting from a risk factor assessment of the entity and comprises components of making a trust decision. The components of making a trust decision comprise an identity of the trusted party; checklist items that measure risk factors used in the assessment; a score of the assessment; a scope of the assessment; and/or a date of the assessment. The trust assertions are stored. One or more templates relating to trustworthiness requirements for the entity are generated, based on at least one of an entity policy, any exceptions to the policy and any rules restricting or enabling variances to the policy; and a contractual obligation of the entity. The templates are stored. A change in at least one of the templates is effectuated, or one or more new templates are generated. Based on a comparison of the stored trust assertions to the stored templates and/or the new templates, the impact of the change or the new template on the trust assertion is determined.

Further, the present invention is directed to a method for modeling trust relationships. One or more trust assertions for one entity relating to a trust relationship with another entity are collected. The trust assertions of the one entity are stored. The trust assertions of the one entity are analyzed to determine how the trust assertions have changed over time.

The present invention is also directed to a method for modeling trust relationships. One or more trust assertions for at least two first entities relating to a trust relationship with a second entity are collected. The trust assertions of the at least two first entities are stored. The trust assertions of at least one of the first entities are compared to those of at least one other of the first entities.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and, together with the description, serve to explain the principles of the invention.

In the drawings:

FIG. 1 is a schematic illustrating the establishment of standards and procedures, and certification of trusted parties, in accordance with a preferred embodiment of the present invention;

FIG. 2A are exemplary questions that may be used in connection with an assessment conducted in accordance with a preferred embodiment of the present invention;

FIG. 2B is an exemplary question that may be used in connection with an assessment conducted in accordance with a preferred embodiment of the present invention;

FIG. 3 is an exemplary trust assertion provided in accordance with a preferred embodiment of the present invention;

FIG. 4A illustrates an exemplary category score issued in connection with an assessment conducted in accordance with a preferred embodiment of the present invention;

FIG. 4B illustrates an exemplary score, shown in binary and hexadecimal format, issued in connection with an assessment conducted in accordance with a preferred embodiment of the present invention;

FIG. 4C illustrates an exemplary score issued in connection with an assessment conducted in accordance with a preferred embodiment of the present invention, allowing for an indication that certain items were not assessed;

FIG. 4D illustrates formatted data that may be provided along with the trust assertion, in accordance with one embodiment of the present invention;

FIGS. 5A and 5B show a message sequence chart illustrating a method for conveying and assessing a trust assertion provided in connection with a transaction in accordance with a preferred embodiment of the present invention;

FIG. 6A illustrates an exemplary template used in connection with the present invention;

FIG. 6B illustrates an exemplary template for processing exceptions to the standards;

FIGS. 7 through 12 are flow charts illustrating preferred embodiments of methods of the present invention; and

FIG. 13 illustrates an exemplary system that may be used to carry out the methods of the present invention.

### DETAILED DESCRIPTION OF THE PREFERRED EMBODIMENTS

The present invention relates to business risk management. Standards (and checklist items based thereon) and compliance practice statements (i.e., procedures for determining compliance) are developed and trusted parties are engaged to perform due diligence and assessments of business risk against the standards. The results of the assessments are delivered in accordance with a protocol. In the preferred embodiment, a consortium (e.g., of businesses) determines the standards, the procedures, and the protocol. However, in other embodiments of the present invention, the standards, the procedures, and protocol may be developed by, and used within, a single entity or between two entities. Establishment of a consortium is preferred, however, as this will accelerate widespread acceptance of the standards and the ability to establish a repeatable process that all users of the information will accept. This reduces the need for multiple assessments of a single entity.

Use of trusted parties provides an unbiased assessment that will be, ideally, universally accepted through the consortium's certification of that trusted party. The trusted party will encode the results of the assessment in a standard format. In a preferred embodiment, some or all of the results of the assessment are embedded in a digital certificate that the trusted party dispenses and/or revokes.

Consumers of the digital certificates will interpret and analyze the assessment results via the digital certificate to determine if the results are acceptable for their risk preference for a given situation. Each time two parties interact electronically, the result of the most current assessment is exchanged through the digital certificate. In a preferred embodiment, any number of actions can be programmed to occur if at any point one party's assessment results do not meet the other party's criteria. The particular action that occurs would depend on the interpreted level of severity, in a preferred embodiment.

It will be noted that many of the examples provided herein relate to evaluating trustworthiness in the context of a business transaction between two unrelated parties (e.g., business partners). However, it will be known to those skilled in the art that the present invention can be used in the context of any trust relationship between or among both unrelated and related parties, or between or among entities within an organization, such as divisions or departments.

Protocol and Framework for Generating Trust Assertions

The present invention provides a protocol for providing standards-based trust assertions, as well as a framework for utilizing trusted parties for generating trust assertions. With these in place, organizational risk postures can be dynamically evaluated for trustworthiness at the time each transaction or connection is made.

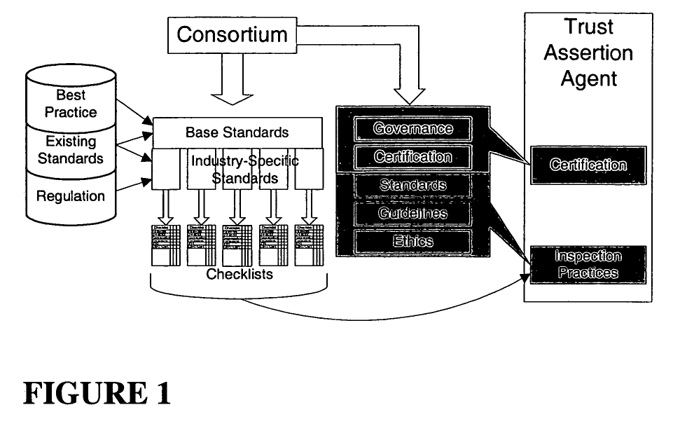

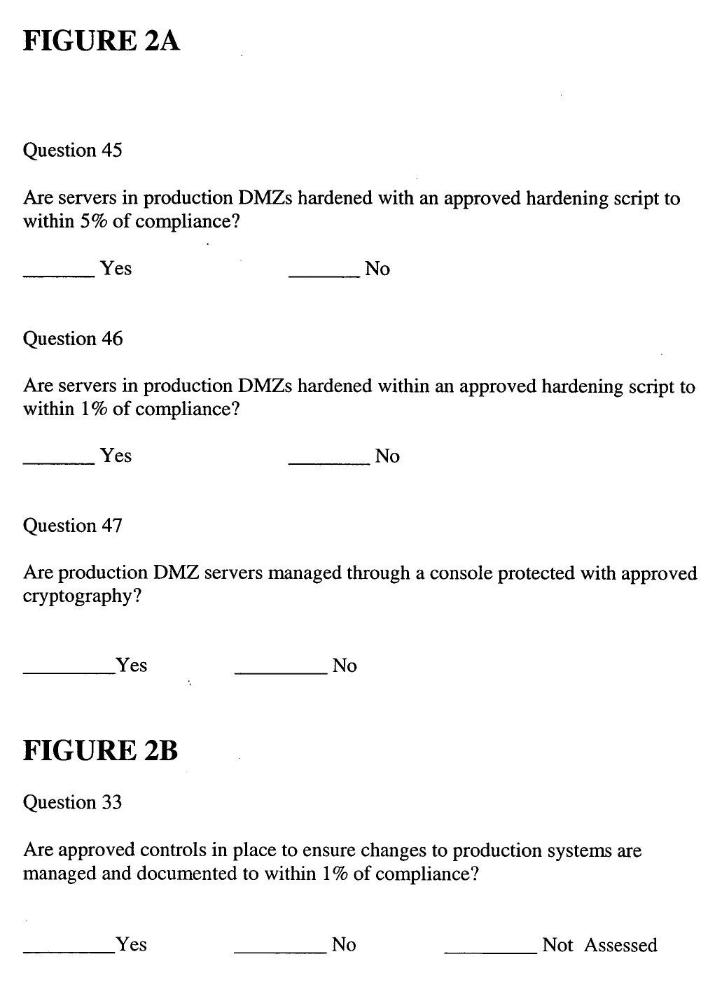

With reference to FIG. 1, a consortium (in one preferred embodiment), uses best practices, existing industry practices and standards (e.g., COBIT, ISO/IEC 17799, Common Criteria, OCTAVE, GAAP, etc.), laws and regulations to establish base standards. Industry-specific standards may be developed based on the base standards. Checklist items that measure risk factors are established from the-base standards. The checklist items ask basic questions to assert compliance with the standards. For example, with reference to FIG. 2A, three exemplary questions are shown. As can be seen, the question does not assert the standard or methodology, but instead asserts compliance with the standard, as a binary yes/no answer. In the example shown, the consortium would establish approved hardening scripts, and include those in the standards. Further, in a preferred embodiment, an additional answer for each question could be included in the standard, to indicate if the standard in question was assessed or not assessed, as shown in FIG. 2B. This would permit the trusted party to indicate that the question was not assessed.

The consortium certifies trusted parties and provides procedures (e.g., standards, guidelines, ethics) for testing and reporting compliance with the standards. In a preferred embodiment of the present invention, the trusted parties voluntarily undergo a certification process whereby their individual inspectors/auditors would need to meet the requirements established by the consortium. This process may include education, training and certification requirements necessary to assess particular parts of the standard, potentially including testing or practical examination as part of the certification process to ensure that third parties are capable of executing the methodologies of the consortium at a stated level. For example, trusted parties verifying compliance with financial and accounting practices may be required to hold a CPA or CISA, and have a bachelor's degree from an accredited college or university, while auditors performing information security assessments may be required to hold a CISSP or CISA. In order to be certified by the consortium, in the preferred embodiment, the trusted parties would be required to uphold and comply with the assertions standards, guidelines, certification practices, and ethics of the consortium, and to comply with consortium governance in matters concerning execution of their duties.

Once certified, the trusted party initiates a trust audit engagement to assess that an entity meets a standard and, in doing so, uses the inspection practices specified by the consortium. The trusted party also uses the standards in assessing the entity. As indicated previously, this includes the methodology and practices that are used to perform and report on the results of the assessment.

When an assessment is completed, the trusted party generates a report with a particular format, in accordance with the present invention. The report asserts five specific things about the assessment and the entity, as follows:

1. Who provided the assessment?

2. What standard was used?

3. What was the score?

4. What was the scope of the assessment?

5. On what date was the assessment conducted?

The answers to these questions provide a relying party with the information it needs to make a trustworthiness determination, provided the relying party trusts the standard and the trusted party, and has established scoring criteria for its organization.

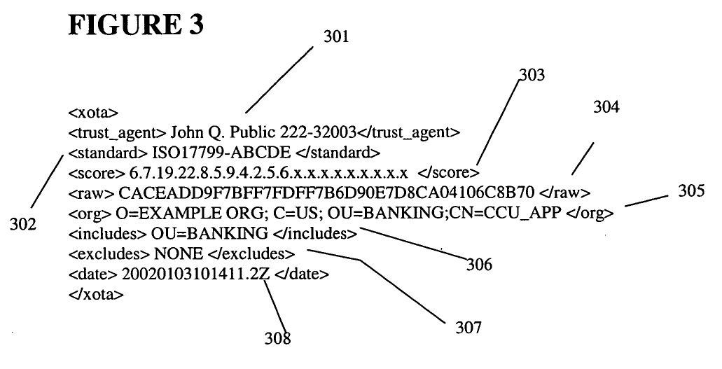

Thus, as a deliverable of the assessment, a trust assertion is issued by the trusted party. In the preferred embodiment, the trusted party issues a digital certificate in X.509 format that contains attribute fields of information (as well as the digital signature of the consortium and a trusted Root Certificate Authority (RCA)) corresponding to the five questions above, and is affiliated with a trusted RCA. Because an X.509 certificate can be readily verified, such credentials would be nearly impossible to forge. FIG. 3 provides an example of a trust assertion issued in accordance with the present invention. The example shown in FIG. 3 illustrates a trust assertion in XML format; however, the trust assertion could be in any format permitting text, such as EDI, comma-delimited, HTML and others, within the scope of the present invention.

The details of an X.509 certificate are standardized by the IETF's RFCs on X.509, which include RFC 3280, 3039, 2560, and 3647, by way of example, as discussed in Ben Hammond, Digital Signatures (McGraw Hill, New York 2002) which is incorporated herein by reference.

As shown in FIG. 3, the trust assertion identifies the identity of the trusted party 301 (the identity of the trusted party need only be included in the trust assertion where a digital certificate is not used); the standard 302 used in connection with the assessment, which would be indicative of the checklist items used in the assessment; the score 303 of the assessment, including the raw score 304; the organization 305 assessed, including the scope of the assessment (in terms of inclusions 306 and exclusions 307); and the date 308 of the assessment.

The identity of the trusted party is, in the preferred embodiment, embodied in a digital certificate, signed by the consortium, which asserts that the trusted party is viable and certified. The identity would be registered with the consortium, in the preferred embodiment.

The standard used in the assessment can be an existing standard (e.g., BS7799, COBIT, WebTrust, Common Criteria, COSO Framework used in connection with Sarbanes-Oxley) or a standard can be created for use in connection with the present invention.

The date that the assessment was completed is included in the assertion. In a preferred embodiment, the date would follow the standards established by the consortium, to ensure that the assessment was timely and that the assertion was not stale when issued. The time would ideally be communicated in a standards-based format, such as Coordinated Universal Time (i.e. GMT) in ASN.1 format, as specified in ISO 8601, as dictated by the consortium. Trusted time stamps which are digitally signed by a disinterested third-party would be implemented as an optional extension of the protocol. For example, the time could be generated by Datum, the U.S. Naval Observatory, or the NIST Atomic Clock. As an extension to the secure timestamp which is embedded in the signed assertion, “Challenge-Response” time stamping may be employed, so that the report itself is hashed in with the trusted time assertions, preventing tampering with the issuance date and time.

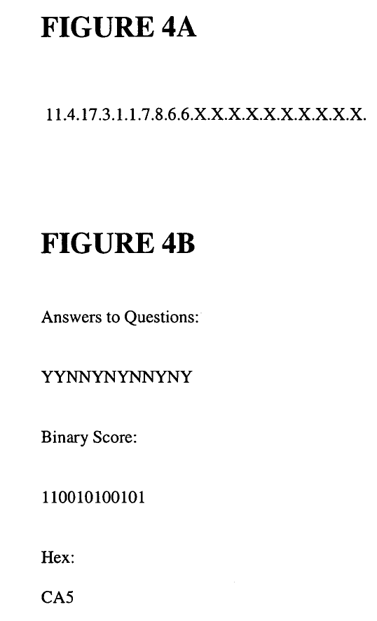

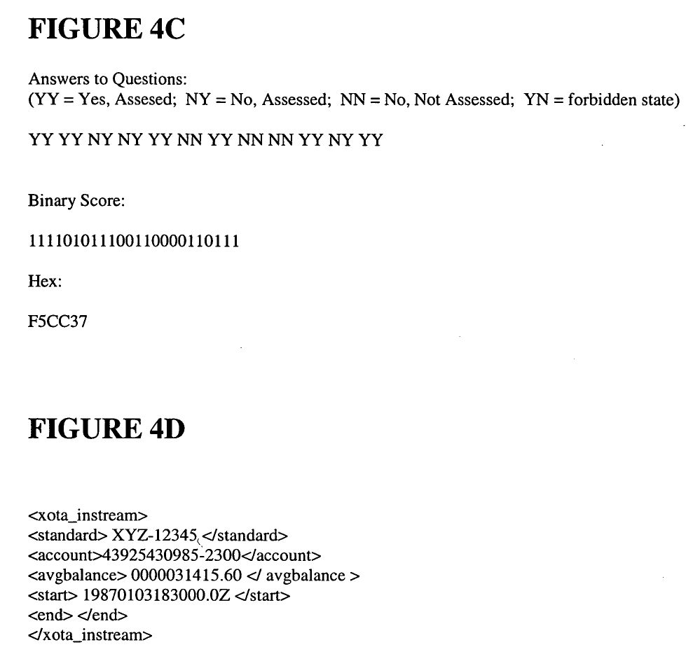

In the preferred embodiment, the score includes two tightly-coupled scores. The components of the score itself may vary and would be decided by the consortium. For example, the questions which are used to provide the assessment are categorized by the consortium into logical groupings. Referring back to FIG. 2A, Questions 45 and 46 would likely be in the same category, while Question 47 might be in another. The score that is conveyed may be delimited by each section, and provide for multiple unique sections, the rest of which would contain placeholders, as specified by the standard used to conduct the assessment. For a score produced by category, this indicates the sum of all “Yes” answers in that category. For example, a standard which used 10 categories might generate the score illustrated in FIG. 4A. This score would indicate a score of 11 on Section 1, 4 on Section 2, . . . , 6 on Sections 9 and 10, and no scores for Sections 11-20, which are simply placeholders. Thus, 11 questions were answered in the affirmative for Section 1, 4 questions were answered in the affirmative for Section 2, and 17 questions were answered in the affirmative for Section 3. For a standard which supports answers of “Not Assessed” for some or all questions, the category scores might generate the same score as illustrated in FIG. 4A, for a standard with 5 categories. This score would indicate a score of 11 on Section 1, with 4 unassessed questions, a 17 on Section 2 with 3 unassessed questions, . . . , 6 on Section 5, with 6 unassessed questions, and no scores for further sections, for which “X” is simply a placeholder.

The raw score would also be included, in the preferred embodiment, using standard ASCII hex representation of the binary scores. Thus, while the individual scores for questions 1-12 might be as illustrated in FIG. 4B, this would equate to the binary score illustrated in that figure, or the hex score illustrated in that figure. Thus, a completed assessment that answered, for example, 300 binary questions could be represented in 75 bytes of hex notation, providing the answers to each question in a means that is easy to process. This provides a compact means of conveying assessment information, to facilitate very granular compliance analysis. For a standard which supports answers of “Not Assessed” for some or all questions, the raw score could include 2 bits for each answer, the first bit indicating the answer to the question (Y=1, N=0), and the second bit indicating if the question was assessed. Referring to FIG. 4C, “11” indicates an affirmative answer for an assessed question, and “00” indicates a negative answer for an unassessed question. As shown in FIG. 4C, this is represented in ASCII hex format as well. “10” indicates an affirmative answer for an unassessed question, which would be an illegal value, and indicate an error state, since it would be impossible to attest to compliance with a standard which was not assessed.

The scope of the assessment is the notation of the areas of the organization that were assessed and any areas specifically excluded. This also conveys the identity of the organization that was assessed, as well as the level of detail of the assessment. Because the protocol is flexible, an organization may only want a certain business function assessed, or perhaps limit the scope to a single department, line of business, state, division or country of operations, by way of example. This information is conveyed in two or more records, in X.500, distinguished name format, as 1) the complete organization assessed, 2) the portion of the organization included in the scope and 3) portions of the organization which were excluded, if any. In the preferred embodiment, the consortium establishes specific scope notation to encapsulate all asserted applications, divisions, or other units “below” the stated scope of the assessment (i.e., those assertions that are more specifically granular than what is conveyed in the scope assertion).

The trusted party may also provide formatted data along with the trust assertion, such as an analysis of the financial position of the entity assessed, accounting information, privacy control information, and other trust components. In the preferred embodiment, the format and attributes of the formatted data are determined by the standard used for the assessment. As an example, FIG. 4D shows formatted data which has been represented in the example in XML formatted data. The standard used in the example, “XYZ-12345”, would define the format, which, in the example, includes an account number of “43925430985-2300”, an average balance of “31415.60” and a start date of Jan. 3, 1997 at 6:30 pm, Coordinated Universal Time (ASN. 1 format), with the “end” date being left blank. In the preferred embodiment of the present invention which utilizes an X.509 digital certificate to convey the trust assertion, this formatted text would be hashed to generate a Message Authentication Code, and then signed by the trusted party as part of the process of issuing the digital certificate. That signed Message Authentication Code would then be included as an attribute field in the X.509 digital certificate, and accompany the formatted text.

The trusted party then signs the report with an RCA-provided digital certificate, which generates and embeds a digital signature. This permits the authenticity of the trusted party and the assertion itself to be verified, and integrity checks to be performed on the assertion as well, in accordance with existing well-known digital certificate verification protocols. In the preferred embodiment of the present invention, the digital certificate provided to the trusted party is issued through the consortium as part of the certification process, and the consortium's digital certificate is issued by an RCA. Thus, the digital certificate containing the trust assertion would have a certification path that proceeds to the trusted party, then the consortium, then an RCA.

While the trust assertion is embodied in a digital certificate in the preferred embodiment of the present invention, other methods of making a trust assertion are available and are within the scope of the present invention. For example, the trust assertion could be included within PGP signed text, OCSP packets, encrypted SOAP, or plain text.

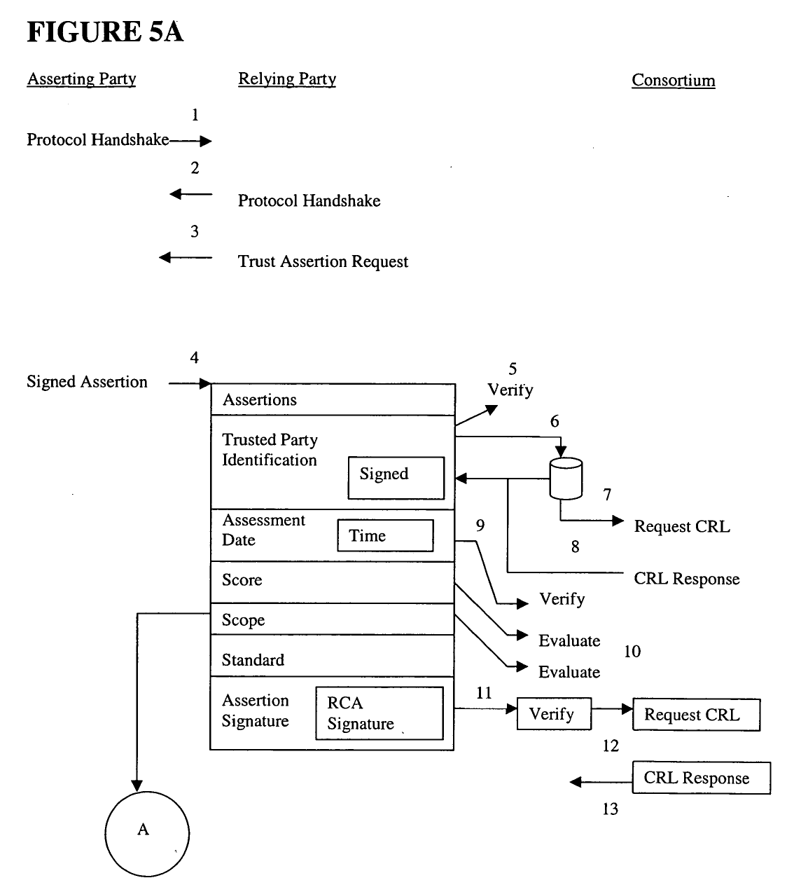

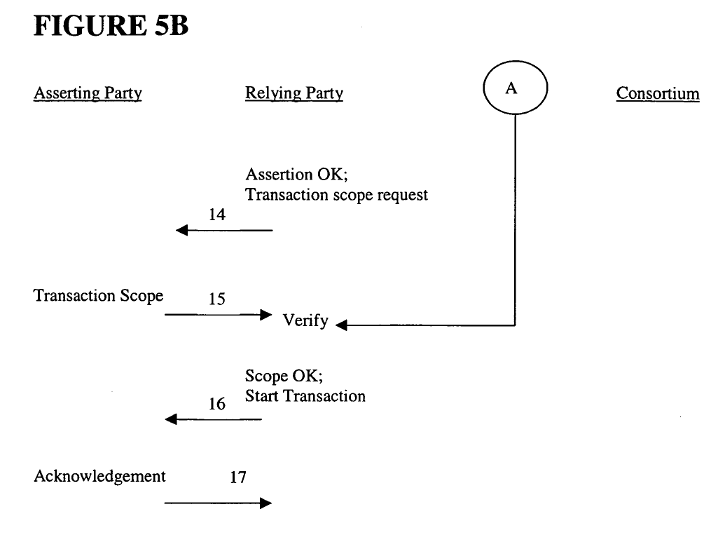

In a preferred embodiment, when establishing a communication session with an organization, part of the connection negotiation could require exchange of one or more digital certificates to establish secure communications; one or more trust assertion certificates could be included in this handshake. Thus, after establishing protocol (e.g., SSL, TLS), the one or more trust certificates are exchanged. The relying party can then extract the information, verify the public keys, and ensure that the integrity of the information is intact and that the digital certificates have not been revoked. This process can be performed in a reasonable amount of time, and is a time-honored process currently used in SSL, TLS and other well-established processes. An example of this process is illustrated with reference to FIGS. 5A and 5B.

Referring to FIG. 5A, in steps 1 and 2, the asserting party and the relying party engage in a handshake during, for example, an HTTPS session. The relying party then makes a trust assertion request in step 3. In response, the asserting party provides the trust assertion, in step 4. In step 5, the identity of the trusted party is verified. In step 6, it is determined whether a local copy of the Certificate Revocation List (CRL) is cached on the server, within the time limits (if any) established by the relying party. If a current copy of the CRL is not available to the relying party, the consortium is contacted (e.g. OCSP request, CRL download) to determine if the trust assertion's digital certificate has been revoked, in step 7, and the response is provided in step 8 (a positive result is assumed in this example). In step 9, the date and time of the assessment is verified. In step 10, the score and the scope are evaluated. In step 11, all entities in the certificate path are verified, including checking the digital signature of the consortium and RCA, which includes consulting the consortium and RCA to determine if any of the digital certificates in the certification path have been revoked, in steps 12 and 13. Referring now to FIG. 5B, assuming the assertion is acceptable, the relying party requests information regarding the scope of the transaction from the asserting party in step 14. The transaction scope is provided and verified in step 15. Assuming the scope is acceptable, the relying party informs the asserting party that the transaction can commence, in step 16. The asserting party provides an acknowledgement, in step 17.

For each trust relationship, all involved organizations establish minimal scoring standards for that relationship, aligned with the organization's policies, regulations, and standards, as well as, for a business transaction, stipulations in a contractual agreement between the parties. The trust assertion analysis process then checks those baseline standards against the assertions, represented as the answers to the five questions detailed above. For example, using the assertion detailed in FIG. 3, the five questions would be analyzed as follows:

Q1: Who provided the audit?

A1: “John Q. Public 222-32003” provided the audit

Our business accepts them, Passed.

Q2: What standard was used?

A2: The standard was ISO 17799-ABCDE

That is a standard we support, Passed.

Q3: What was the score?

A3: The score was 6.7.19.22.8.5.9.4.2.5.6

Minimum for ISO17799-ABCDE is 5.5.17.22.8.2.9.3.2.3.3, Passed.

Q4: What was the scope of the audit?

A4: The scope was the OU=Banking

Business application is in Banking Division, Passed.

Q5: What date was the audit conducted?

A5: The date was Jan. 3, 2002

Maximum age is 18 months. Failed. Untrusted state.

Assuming in the above example, for purposes of illustration, the rule for the score for a particular organization was 5.7.17.22.8.2.9.3.2.3.3. Because the second item in the score meets the minimum required by the rule (i.e., 7), conditional approval is provided. However, the relying organization may decide that a further interrogation of the score is necessary, for example, to determine whether the raw score complies with the rule established by this organization. Assuming compliance, it will be passed.

Provided a contract is in place, the standards are an extension of contractual obligations stipulated in an agreement between the two companies, so the terms should be clear to all involved, and the trust analysis merely reflects the trust embodied in the contract. Because the standard and scope are flexible, each entity can determine what level and scope is required for the trust posture necessary for that particular trust relationship and context. As discussed previously, scope can readily be defined through embedded X.500 notation in the certificate, providing a pointer to Fully Distinguished Names (FDNs) and Relative Distinguished Names (RDNs). This would permit the application to determine how much of the infrastructure was covered by the auditor's assessment.

By providing the trust assertions in X.509, Certificate Revocation List (CRL) checking becomes an important control of the inventive methodology. If an assessment score downgrade is determined through an audit, event or discovery, the trusted party would revoke relevant previously-issued digital certificates and reissue the new one. Also, through the X.509 certificate path, the consortium can revoke the certificate of the trusted party if the trusted party becomes untrusted. For an assessment score increase, a new certificate may be issued without revoking the “weaker” assertion, to avoid a denial of service in ongoing transactions using trust assertions. Checking certificate revocation (e.g. through CRLs, OCSP) ensures that the trust rating is still viable, and provides protection against fraud. Further, it permits all other parties relying on that trust assertion to know, nearly instantaneously, that the trust model has changed for that transaction.

Thus, the present invention involves the combination of the methodology and practices, which use trusted parties, with the protocols to report the scope and standard used during an assessment, and the score of that assessment. Because the trust assertion is provided via ubiquitous X.509 digital certificates, in the preferred embodiment, nearly any system designed to provide authentication could readily request and analyze trust assertions. Both traditional client-server e-commerce and Web Services business applications can dynamically determine session trust, application trust and entity trust, all at execution time.

The same technology could be embedded in file transfer and terminal emulation technologies (e.g. SSH, SCP, ftp) to determine trustworthiness for logins, to protect file transfers and terminal emulation sessions. By placing trust assertion processing in e-mail gateways, spam can be deflected or routed based on the trust assertions embedded with the message, for example, by mail router trust assertions.

Trustworthiness of executables could also be governed if a secure kernel would not only verify the integrity against known, signed hashes, but would also perform trust assertion validation. By performing an assessment of the executable's trust assertion, most importantly by assessing the viability of the certificate against a CRL, the kernel would be able to determine if the executable had lost its certification, perhaps because vulnerabilities had been published against that version of the application. The invention presents useful extensions for a trustworthy computing environment, for example, in a government or military application requiring certified executables.

Trust modeling using the present invention is also viable for the business-to-consumer environment, and could be built into a browser quite easily to provide a security assessment automatically, just as P3P does for privacy. Java applets, ActiveX controls, JavaScript, VBScript and embedded components could be required not only to be signed, but also to include a trust assertion for the application. Consumers would be able to determine the trustworthiness of the application, company and privacy controls automatically at download, which could be a very powerful tool for consumers to identify malicious software or untrustworthy companies.

Centralized Governance/Modeling

To create a trust governance model in accordance with the present invention, trust assertions are forwarded to a centralized location in an organization, ideally into an authentication and authorization processing engine which would already have the necessary infrastructure for such processing. This then permits trust model “templates” to be used for governance, and would isolate the trust model authentication to a high-trust system, which would help prevent malicious or errant programming from bypassing trust governance at the application level.

A mapping of existing rules, as expressions of policies, temporary or permanent exceptions granted to policy, contractual obligations, and/or particular rules restricting or enabling policy variances are generated as templates. These templates are applied to modify scoring of specific trust relationships, which are modeled against business functions, departments, etc., based on the defined scope of each template. This centralized engine, hereafter referred to as Certified Trust Assertions (CTA) Governance, uses templates that would typically be created by a centralized governance body, such as the comptroller, CISO or CIO office within an entity.

By collecting CTAs, and storing them in a centralized database along with the templates of the CTA Governance described above, an executive information system (EIS) can be created that would enable dynamic modeling of trust relationships, by way of example.

A CTA EIS permits “What-if” analysis of specific policy changes and their impact to active and potential trust models. The aggregate collection of these templates defines the fabric of trust models for the organization. Thus, security, privacy, compliance or risk officers, for example, would be able to determine the impact of policy, regulatory, or business practice changes in near-real time. For example, a CIO could determine if all the existing trust models would permit a more relaxed availability SLA (service level agreement) posture if that was included as a point which was tracked by the CTAs and CTA Governance templates in the CTA EIS. General Counsel or Privacy Officer could determine the impact of new privacy legislation on the security posture of existing trust relationships.

By collecting the baseline and effective CTA Governance templates of business partners, the inverse could be modeled as well by a CTA EIS, which would determine which trust relationships might be effected by compliance changes. Because any change in security or other trust components would impact the trust models on both sides of the relationship, it is important to model the complete trust “fabric” of the organization, as well as the specific business trust models which are shared with established business transactions/functions.

Further, it would be useful for an entity to be able to review the trust assertions of other entities with which it has, or may in the future have, a trust relationship, to determine how the trust assertions have changed over time. Moreover, it would be useful for an entity to be able to compare the trust assertions of multiple other entities (with which it has, or may in the future have, a trust relationship) to each other.

In a preferred embodiment, the templates are provided in much the same format as the trust assertions (CTAs) may include:

1) scope

2) standard

3) score (category & raw score)

4) issuer

5) issue date

6) expiration date

If an X.509 certificate were used to convey the template, the issuer, issue date and expiration date would be provided by the certificate; in this instance, only the scope, standard, and score would need to be explicit in the template assertion.

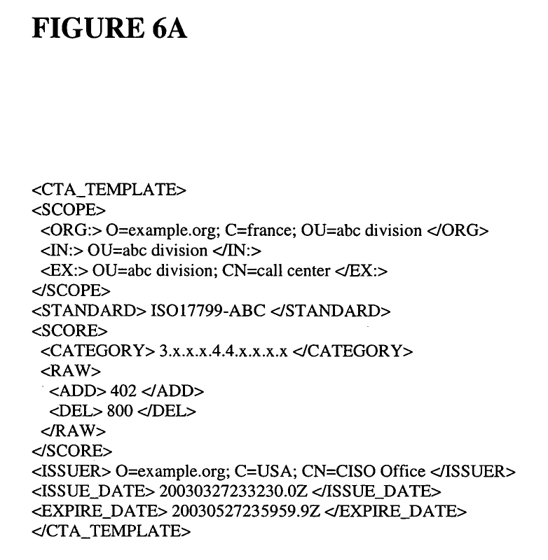

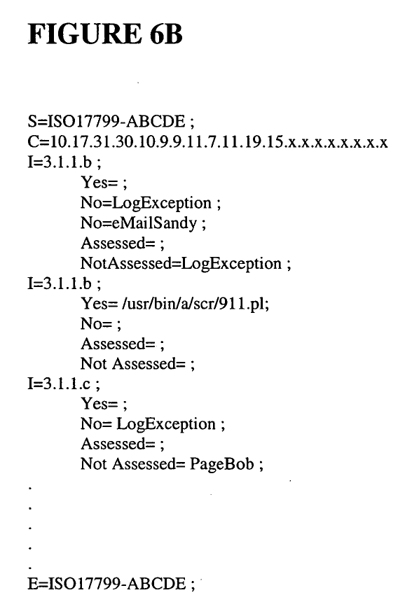

The following provides additional details of the template, in accordance with a preferred embodiment of the present invention. An example is shown in FIG. 6A. In other embodiments, the details of the template may vary from that described herein.

The scope of the template's coverage is provided, as expressed in X.500 format and compliant with the CTA protocol. Meta-tags are used to indicate the boundaries of the scope, which could support XML format of the scope. As shown in FIG. 6A, the ORG: tag defines the total organization above the level of the scope, and defines the path much like a chain-of-command on an organization chart. This enables all trust assertion templates together to form a complete mapping of the enterprise trust models, just like an organizational chart enables employees and management to understand where they fit into an organizational model. The IN: tag defines specific areas which are in the scope of the template, where the EX: tag defines specific areas which would be out of scope, and would not have the template cascaded to that subordinate level.

In the example shown in FIG. 6A, the scope of the template is for the Example.org organization, and specifically for the entire ABC Division in France, except for the Call Center. The scope also does not extend to other entities in France which are outside the ABC Division. Thus, areas which are excluded would, in the absence of other specific templates, revert to the enterprise default, and ignore the template which is out of scope.

Although it is likely that a single organization will have a single standard (e.g. ISO/IEC 17799, Common Criteria, etc.) that forms the core of their security policy, and with which they will assert compliance, it is highly unlikely that any organization of sufficient size will only need to evaluate against a single standard. These entities will need the ability to map against multiple standards, particularly in heterogeneous environments and relationships that span industries, countries, and/or must report compliance to multiple, diverse regulatory bodies. For each standard being governed by a template, a separate template would have differing actions, likely within the same scope as other templates for differing standards. Although this would create differing trust maps depending on how the standards overlap, it would permit differing entities with disparate standards to assert their trustworthiness against a single area of the organization, and also permit modeling of those trust relationship in the CTA EIS.

The score is provided by two fields: category score and raw score. The first score field is a category scoring standard that provides the baseline score by category that correlates to the associated standard for this record. Thus, the baseline score for that section of the standard is established for the scope of this template. Second, a raw score is established so that individual answers to the standard can be assessed against the template. The template at the enterprise level (or whatever the scope indicates is the top level) provides the baseline posture for that standard, while subsequent, subordinate templates modify the top-level template.

Both the category and raw score have the same hierarchy for subordinate “cascading”; but are evaluated differently. The category score portion of the template which corresponds to the division-level template is illustrated in FIG. 6A, as “3.x.x.x.4.4.x.x.x.x”. The following illustrates an exemplary format of the category score:

n.n.n.n.n

where “n” has one of two values:

x—no changes or score in this section

number—new value for that section

For example, assuming the scope is limited to the level indicated below alone, the score may be as follows:

enterprise: 6.3.7.9.2.5.x.x.x.x

division: 3.x.x.x.4.4.x.x.x.x

application: 4.x.8.8.x.x.x.x.x.x

In this example, the effective template at each level, after applying templates at each level, would be:

enterprise: 6.3.7.9.2.5.x.x.x.x

division: 3.3.7.9.4.4.x.x.x.x

application: 4.3.8.8.4.4.x.x.x.x

The format of the raw score is described as follows, with reference again to FIG. 6A. The raw score is represented as two values with meta-tags, representing changes to the binary score, where the binary score represents requirements for specific “questions” for each applicable standard. Thus, the binary score “100111110001” would indicate answers of “YNNYYYYYNNNY”, or “9F1” in hexadecimal notation. At the top level of the organization, the template score establishes the baseline for the entire organization. For the template, one raw score, ADD:, would add flags as requirements, where the other raw score, DEL:, would delete flags as requirements. Thus, a “1” in a position for ADD will set that position to “1”, while a “1” in a position for DEL will set that position to “0”. For the template, a “0” in any position for either ADD or DEL indicates that there is no action by the template for that position. To illustrate:

| | 0 | 1 |
|---|---|---|
| ADD | null | ON |
| DEL | null | OFF |

(where “null” indicates “no action”).

Referring to FIG. 6A, the exemplary template shows an ADD of “402” for the abc division, and a DEL of “800”. These same values are shown in the example below. The following is an example that shows the score represented in binary form, even though the actual scores are hex, and presumes that the division and application scores have a scope which is only at that level, without cascading to subordinate levels:

| | binary | hex | effective score |
|---|---|---|---|
| enterprise: | 100111110001 | 9F1 | 100111110001 |
| division: <ADD> | 010000000010 | 402 | 110111110011 |
| division: <DEL> | 100000000000 | 800 | 010111110011 |
| application: <ADD> | 100000000001 | 801 | 110111110011 |
| application: <DEL> | 000010011000 | 098 | 110101100011 |

Thus, after modification by the division and application templates, the effective score in this example is 110101100011, or “D63” in hexadecimal notation. For trust models that were evaluated at the application level in the above example, “D63” would be the minimum permissible score for compliance with the associated standard and templates.

In the preferred embodiment, the issuer is provided in the template in X.500 DN (Distinguished Name) format, an example of which is provided in FIG. 6A as an issuer of “O=example.org; C=USA; CN=CISO Office”. The issuer may not be actively evaluated by a trust model in accordance with the present invention, but is included for governance so that CTA Governance administrators and users can associate the template with the issuing party.

The issue date and expiry date may be provided in Coordinated Universal Time (i.e. GMT) in ASN.1 format, as specified in ISO 8601. Both issue and expiry date need to be explicitly stated only where the templates are not embedded in an X.509 certificate.

The CTA Governance processing provides centralized processing and governance of transactions by performing the same processing as the present invention for determining trustworthiness based on the five questions. For each business application/trust relationship, the effective score, after application of all templates, is used as the baseline standard for grading against the assertions, as represented as the answers to the five questions detailed in the inventive protocol. For example, assuming the effective template category score following processing of all applicable templates is “6.6.16.22.8.4.9.3.2.5.3”, and using the assertion detailed in FIG. 3, the five questions would be analyzed as follows:

Q1: Who provided the audit?

A1: “John Q. Public 222-32003” provided the audit

Our business accepts them, Passed.

Q2: What standard was used?

A2: The standard was ISO17799-ABCDE

That is a standard we support, Passed.

Q3: What was the score?

A3: The score was 6.7.19.22.8.5.9.4.2.5.6

Minimum for ISO17799-ABCDE is 6.6.16.22.8.4.9.3.2.5.3, Passed.

Q4: What was the scope of the audit?

A4: The scope was the OU=Banking

Business application is in Banking Division, Passed.

Q5: What date was the audit conducted?

A5: The date was Jan. 3, 2002

Maximum age is 18 months. Failed. Untrusted state.

In a preferred embodiment of the present invention, determination of a failed trust relationship, such as the example above, would typically cause one or more actions to be taken by the CTA Governance engine, such as but not limited to returning an error condition to the process which submitted the CTA, sending an e-mail to the template issuer and compliance officer, triggering an alert through a communication interface, logging the processing error and/or rejecting the transaction.

In a preferred embodiment of the present invention, processing of exceptions and errors by the CTA Governance would be tied directly to the standard, and would permit multiple actions to be taken for each checklist item, category, and/or standard which failed. A template is created as part of the CTA Governance template building process, providing for stated actions for each item in the checklist, for each possible answer. In practice, this would involve specifying a few actions that would be triggered for all actions for which there is non-compliance. FIG. 6B provides an example of what this file might resemble for processing exceptions to the standards, as a semi-colon (;) delimited file. In the example, the Standard is specified on the first line, with the “S=” tag, and identifies the applicable standard, followed by the line “C=10.17.31.30.10.9.9.11.7.11.19.15.x.x.x.x.x.x.x.x”. To facilitate scoring processing, the total number of questions are expressed for each section, so that the scoring processing can be performed either by category scoring, or by raw score. In this example, the standard ISO17799-ABCDE has 10 questions in Section 1, 17 questions in Section 2, 31 questions in Section 3, . . . , 19 questions in Section 11, 15 questions in Section 12, for a total of 179 questions. Thus, when processing, and no compliance issues are detected in Sections 1 or 2, the processing engine could jump directly to question 28, which is the start of Section 3. Following the identification of the category sections in the example file, all the lines starting with “I” identify the checklist item which was assessed, and then each possible answer under those respective items. In the example in FIG. 6B, if item 3.1.1.b was assessed, and was answered in the affirmative, then no action is taken, as indicated by the lack of a command following the “Yes” and “Assessed” tags for that section. However, if item 3.1.1.b was answered “No” in this example, then process “eMailSandy” and “LogException” are triggered. If the item was not assessed, then only “LogException” is triggered. The CTA Governance engine would process through the file, for all applicable standards being scored, and triggering the appropriate actions for any of the items which were scored as an exception to organizational policies and standards. Other fields may be used to further segregate the processing file to provide for specific actions based on one or more of business partners or entities, organizational units, applications and/or business functions.

For organizations of any significant size engaging in multiple trust relationships which are governed by the present invention, it may be that not all entities will choose to be assessed with the same standard. Rather than force an entity to be assessed by multiple standards, potentially with significant overlap in the checklist content and procedures, CTA Governance templates can be utilized to provide a translation from one standard to another. The most direct way to achieve this, for example, would be for an organization's compliance officer to go through the process of comparing the existing enterprise standard in force with the standard used for the new assessment. Referring to FIG. 2A, which shows three exemplary checklist questions, if Question 45 was required for the existing policies and practices, and Question 46 was one that originated on the differing standard, the compliance officer could equate the two questions as roughly equivalent. Provided the underlying server hardening procedures espoused by the standard were likewise complementary, the compliance officer would be able to state that Question 46 under the new standard would provide for compliance for Question 45 under the existing standard, and would require an affirmative answer (i.e. “Y”) for that question on the new standard. By repeating this process for all existing standards, the compliance officer would be able to create a template for the “new” standard that effectively translates the existing entity standards and practices into the new standard. Most significantly in this example, the compliance officer would need to determine what requirements are not met by the new standard, and which would result in a compliance gap that would have to be mitigated through other controls, potentially by having a third party perform an assessment of the missing questions, to obtain a trust assertion for those missing items. Once this process is complete, the organization would now be able to use that new template to score trust assertions using that new standard, in essence speaking “two languages” for the same business context.

For environments where a higher trust posture is required, templates would be embedded in an X.509 v3 certificate. Where X.509 is not viable or desirable (e.g. perhaps because of a lack of PKI), trust in the integrity of the templates could be established by generating a signed hash using another asymmetric algorithm, or hash which includes a shared secret. Neither of these solutions may be as trustworthy or secure as one established in the framework of PKI using X.509 certificates, largely due to the lack of certificate revocation, which is a key component to expiring templates based on events rather than time. However, all three are viable means for ensuring the integrity and authenticity of the template in accordance with the present invention.

When implementing templates through the CTA Governance model in accordance with the present invention, templates may be layered one at a time, from general to specific, until the effective trust model is established. Where two trust templates appear to conflict with differing, specified actions, the CTA Governance engine would be set to determine the order in which templates would be applied, perhaps by date (e.g., LIFO). An alert may be triggered for the administrators of the CTA Governance engine to resolve the conflict.

The following provides an example of an implementation of the present invention. Enterprise ABC has a policy which permits password authentication for most systems, but requires two-factor or biometric secure authentication for all systems processing information which has been classified as “Top Secret”. An enterprise template is established for the entire organization that reflects the security policies and minimal trust requirements for the governing security standard. Business Unit XYZ, a division of Enterprise ABC, establishes a business relationship with Corporation W. For this relationship, a trust model is established to conduct business using a system which processes information of a lesser classification than “Top Secret”, perhaps “Confidential”. However, the Business Unit XYZ decides that two-factor authentication is required, and establishes a contract for the business relationship that mandates two-factor authentication. This deviation from policy would be provided through a template created for this specific business function, which would ensure that two-factor authentication was used.

Subsequently, days before implementation, an audit finding determines that the other party is not in compliance with the contract due to problems implementing two-factor authentication. After negotiation, the parties agree that Company W can have three months to fix the problem. The CISO office then creates a temporary template which permits password authentication, but which expires in three months. This will permit the business model to continue, and permit Company W to come into compliance with the contract, but ensure it undergoes an assessment by a trusted party and generate a new trust assertion within three months. This example thus demonstrates the layering of trust templates, and how it can provide a governance model to resolve compliance issues.

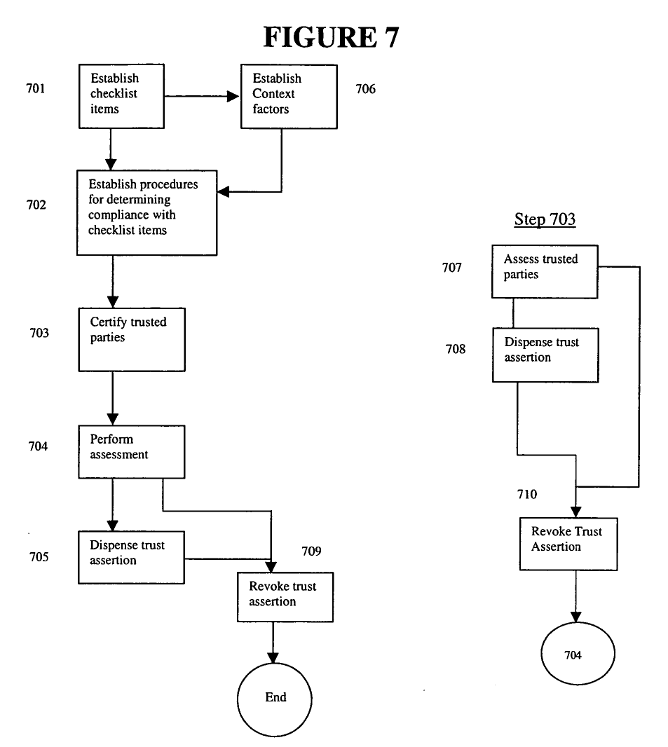

The methods of the present invention are illustrated with reference to the flowcharts of FIGS. 7 through 12.

FIG. 7 illustrates a method for implementing a risk management program. In step 701, one or more checklist items are established. The checklist items measure risk factors. The risk factors may relate to any topic within the scope of the present invention, such as security, safety, supply chain, and finances. In step 702, one or more procedures for determining compliance with the checklist items are established. The checklist items and/or the procedures may be industry-specific. In step 703, one or more trusted parties that assess entities against the checklist items using the procedures are certified. In step 704, the trusted parties perform an assessment of each of the entities based on the checklist items using the procedures. Based on the assessment, in step 705, the trusted parties either dispense a machine-readable trust assertion comprising one or more attributes relating to a result of the assessment and/or revoke, in step 709, a previously-issued machine-readable trust assertion comprising one or more attributes relating to a result of a previously-performed assessment. In the preferred embodiment, the trust assertion comprises a digital certificate. However, other ways of expressing the trust assertion will be known to those skilled in the art and are within the scope of the present invention.

The result of the assessment comprises, in one preferred embodiment, a trust assertion score associated with the checklist items. The result of the assessment may also comprise, in other embodiments, a scope of the assessment, determined based on the context factors, wherein the scope of the assessment comprises an identifier for the assessed entity, a portion of the entity included in the assessment, and any portion of the entity excluded from the assessment.

In another embodiment, one or more context factors used in performing the assessment are established in step 706. The context factors comprise at least one of an entity identifier and an entity organizational structure. In some embodiments, the checklist items and/or the context factors are established by a consortium.

In some embodiments, the trusted parties are certified (step 703) in accordance with a certification process established by the consortium. The consortium performs an assessment of the trusted parties based on the certification process in step 707. Based on the assessment, in step 708, the consortium either dispenses a machine-readable trust assertion comprising one or more attributes relating to a result of the assessment and/or, in step 710, revokes a previously-issued machine-readable trust assertion comprising one or more attributes relating to a result of a previously-performed assessment.

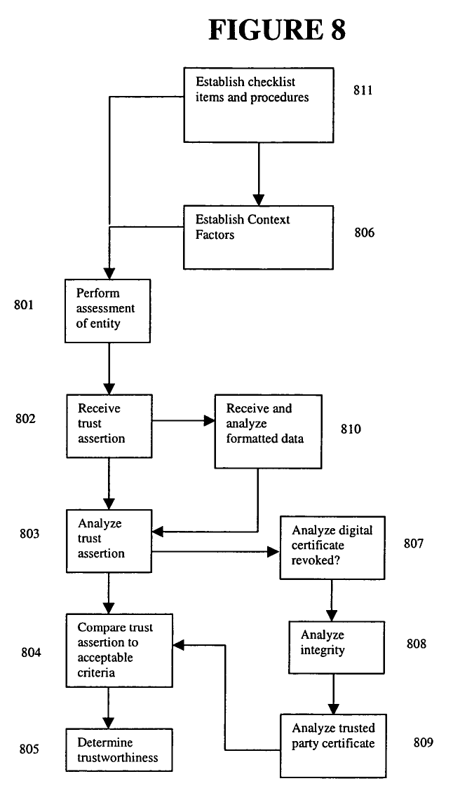

With reference to FIG. 8, a method for conveying an assessment of an entity is illustrated. In step 801, an assessment of the entity is performed based on one or more checklist items that measure risk factors and one or more-procedures for determining compliance with the checklist items. The checklist items and/or the procedures may be, in some embodiments, established by a consortium in step 811. In step 802, a machine-readable trust assertion, issued by a trusted party resulting from the assessment of the entity, is received from the entity. In step 803, the trust assertion is analyzed to determine (1) an identity of the trusted party, (2) checklist items used in the assessment, (3) a score of the assessment, (4) a scope of the assessment; and (5) a date of the assessment. In step 804, the identity of the trusted party, the checklist items used in the assessment, the score, the scope and the date is compared to an acceptable trusted party identity, acceptable checklist items, an acceptable score, an acceptable scope and an acceptable date. In step 805, trustworthiness of the entity is determined based on the comparison.

In some embodiments, in step 806, a consortium establishes one or more context factors used in performing the assessment. The context factors comprise at least one of an entity identifier and an entity organizational structure. The scope of the assessment is determined based on the context factors and comprises an identifier for the assessed entity, a portion of the entity included in the assessment, and any portion of the entity excluded from the assessment.

In some embodiments, the trust assertion comprises a digital certificate comprising one or more attributes relating to the trust assertion. In this embodiment, in step 807, the digital certificate is analyzed to determine validity. The analysis may include analyzing cryptographic components in the digital certificate. In a preferred embodiment, the validity determination comprises determining if the digital certificate has been revoked. In some embodiments, the trust assertion is analyzed to determine integrity, in step 808.

In a further embodiment, the identity of the trusted party is embodied in a digital certificate, signed by a consortium asserting that the trusted party is viable and certified by the consortium. In this embodiment, in a further step 809 the digital certificate of the trusted party is analyzed to determine if the digital certificate has been revoked.

The trust assertion score may be represented in a variety of formats within the scope of the present invention. For example, the score may be represented in binary format and, for example, provided in a hexadecimal representation of the binary format. The trust assertion score may be provided as a sum of binary scores, in base-10 numeral format.

In some embodiments, the trust assertion score is represented for at least one of the checklist items to have not been assessed. Thus, the score can convey whether the checklist item was assessed and passed; was assessed and failed; or was not assessed.

In some embodiments, formatted data associated with the trust assertion is provided and analyzed in step 810.

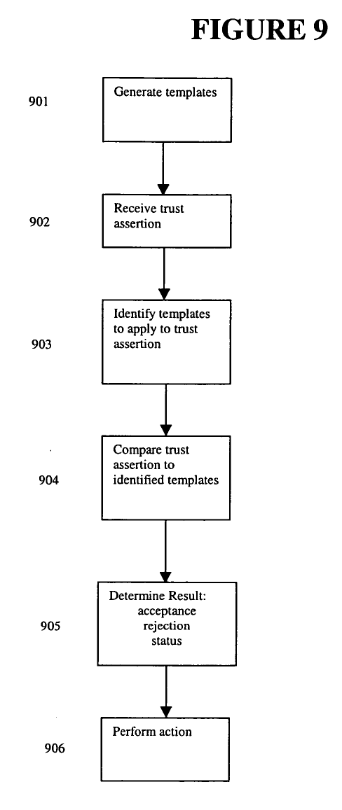

With reference to FIG. 9, a method for implementing trust governance for an entity is illustrated. In step 901, one or more templates relating to trustworthiness requirements for the entity are generated, based on at least one of an entity policy, any exceptions to the policy and any rules restricting or enabling variances to the policy; and a contractual obligation of the entity. The trustworthiness requirements may relate to any topic, within the scope of the present invention, such as security, safety, supply chain, and finances. In step 902, a trust assertion is received in connection with a trust relationship between two or more entities. The trust relationship may relate to a transaction, although other trust relationship scenarios are within the scope of the present invention. The trust assertion is issued by a trusted party resulting from an assessment of one of the entities. The trust assertion comprises components of making a trust decision, which may include one or more of an identity of the trusted party; one or more checklist items that measure risk factors used in the assessment; a score of the assessment; a scope of the assessment; and a date of the assessment. Where the trust relationship is a transaction, the components of making the trust decision further comprise an identity of the transaction and, in some embodiments, include a date of the transaction. In step 903, one or more of the templates to apply to the trust assertion are identified. In step 904, the trust assertion is compared to the identified templates. In some embodiments, this comparison may be performed in a specified order. In step 905, a result is determined based on the comparison. The result includes at least one of an acceptance, a rejection and a processing status message. In some embodiments, in step 906, one or more actions are performed. The actions performed are indicated in associated templates and are associated with at least one of the result and attributes of the assessment.

In one preferred embodiment, the templates and/or the trust assertions are machine-readable. In other embodiments, one or more of the templates facilitates conversion of a trust assertion of a first type to a trust assertion of a second type.

Each of the templates may include, in one preferred embodiment, one or more of a portion of the entity covered by the template, and any portion of the entity excluded by the template; checklist items that measure risk factors used by the portion of the entity covered by the template; a score required by the template; an issuer of the template; an issue date of the template; and an expiry date of the template.

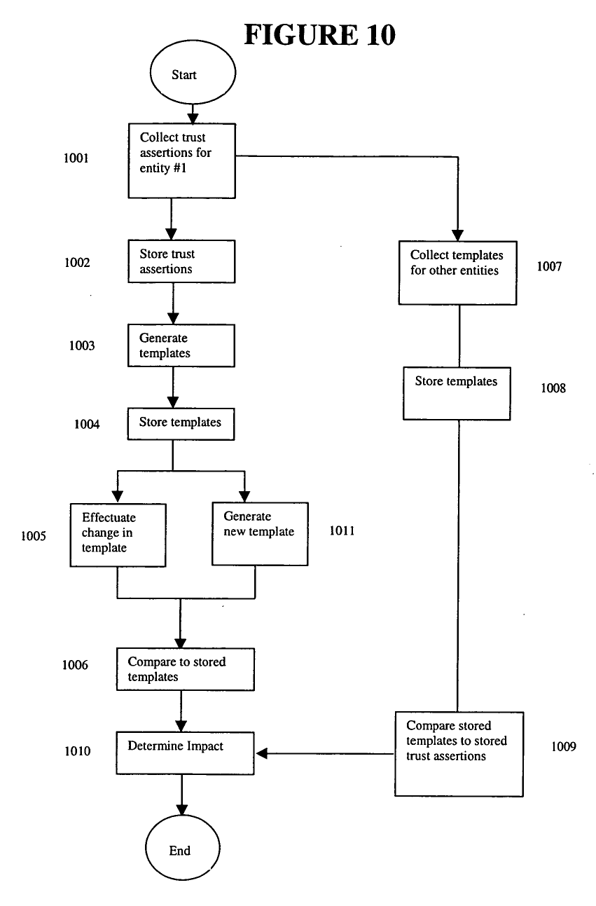

With reference to FIG. 10, a method for modeling trust relationships is illustrated. In step 1001, one or more trust assertions for an entity are collected. The trust assertions relate to a trust relationship between the entity and one or more other entities. Each of the trust assertions is issued by a trusted party resulting from a risk factor assessment of the entity and comprises components of making a trust decision. The components of making a trust decision include one or more of an identity of the trusted party; checklist items that measure risk factors used in the assessment; a score of the assessment; a scope of the assessment; and a date of the assessment. In step 1002, the trust assertions are stored. In step 1003, one or more templates are generated. In one preferred embodiment, the templates are machine-readable. The templates relate to trustworthiness requirements for the entity, based on at least one of an entity policy, any exceptions to the policy and any rules restricting or enabling variances to the policy; and a contractual obligation of the entity. In some embodiments, one or more of the templates facilitate conversion of a trust assertion of a first type to a trust assertion of a second type.

In step 1004, the templates are stored. In step 1005, a change is effectuated in at least one of the templates or in step 1011 one or more new templates are generated. In step 1006, based on a comparison of the stored trust assertions to the stored templates and/or the new templates, the impact of the change or the new template on the trust relationship is determined in step 1010.

In another embodiment, in step 1007 one or more of the trust assertions for one of the other entities is collected and, in step 1008, stored. In this embodiment, in step 1009, determining the impact of the change or the new template on the trust relationship is further based on a comparison of the stored templates to the stored trust assertions of the other entity.

In one embodiment, the trust relationship relates to one or more transactions. In this embodiment, the components of making the trust decision further comprise an identity of the transaction and, perhaps, a date of the transaction.

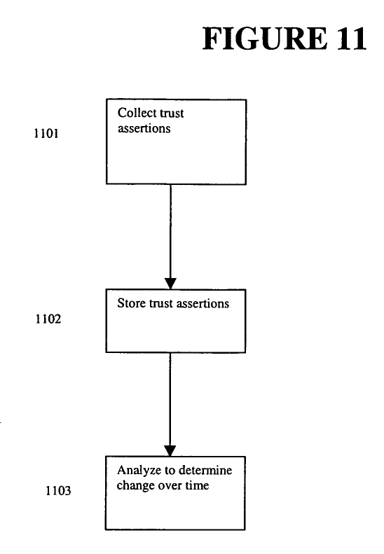

With reference to FIG. 11, a method for modeling trust relationships is illustrated. In step 1101, one or more trust assertions for one entity relating to a trust relationship with another entity are collected. The trust assertions of the one entity are stored in step 1102. In step 1103, the trust assertions of the one entity are analyzed to determine how the trust assertions have changed over time.

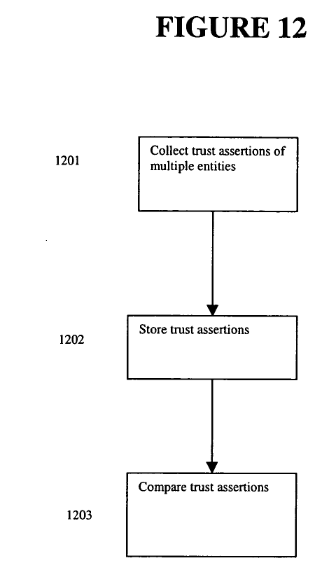

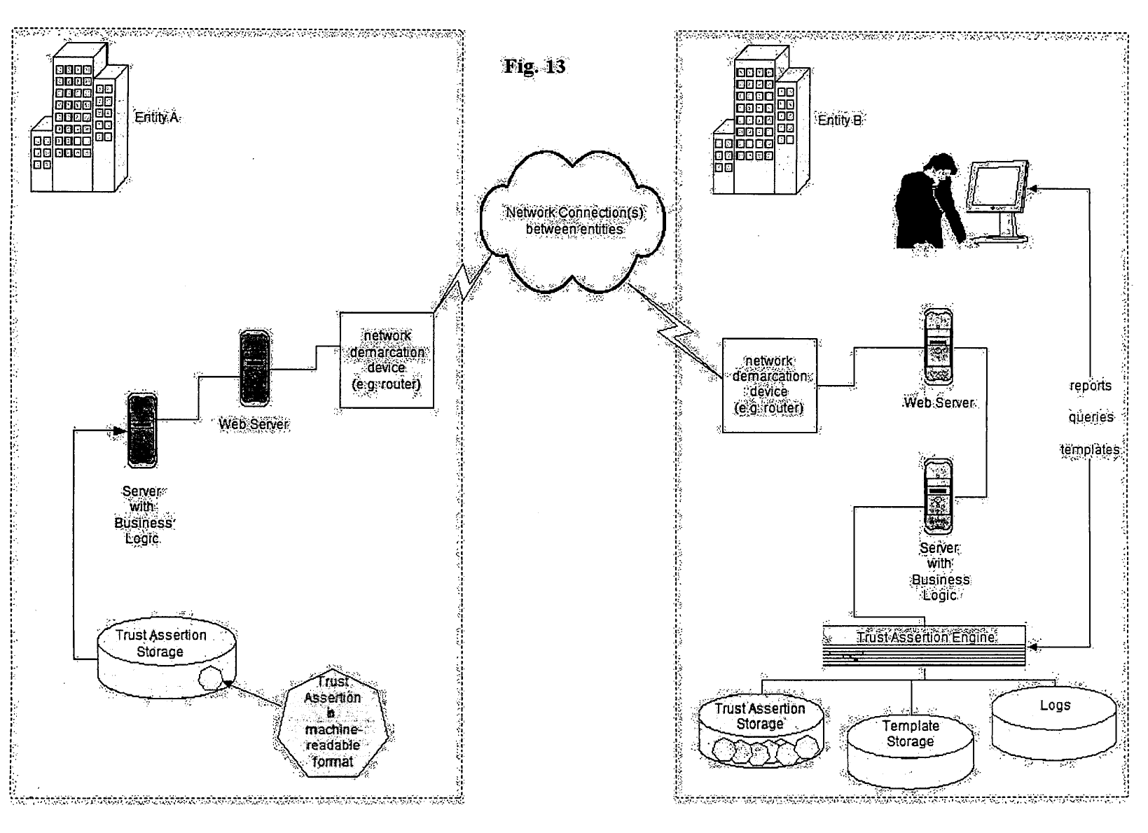

With reference to FIG. 12, another method for modeling trust relationships is illustrated. In step 1201, one or more trust assertions for at least two first entities relating to a trust relationship with a second entity are collected. In step 1202, the trust assertions are stored. In step 1203, the trust assertions of at least one of the first entities is compared to at least one other of the first entities.

With reference to FIG. 13 , a system for carrying out the methods of the present invention is illustrated. Entity B maintains within its systems a trust assertion engine that is used to centralize and automate the processing of various aspects of the present invention, including one or more of receiving trust decisions and transactional information, analyzing trust assertions, identifying templates, storing and retrieving templates, storing and retrieving trust assertions, combining templates, scoring trust assertions, rendering trust decisions, returning error and/or processing codes, logging events, and providing management functions for the engine. In one embodiment of the present invention, the engine provides processing of digital certificates, including at least one of digital signature verification, integrity checking, certificate path verification, and/or revocation checks for one or more digital signatures. In one embodiment of the present invention, the engine provides script execution, trigger execution, alerts or other communications based on exception processing. In one embodiment of the present invention, the engine provides a query facility for ad-hoc reporting features. In one embodiment of the present invention, the engine communicates directly with external entities, acting as a communication gateway or portion of a communication gateway, passing on communications only if the other entity is deemed trustworthy. Templates of Entity A are maintained in a database, as is log information.

The present invention provides for a number of advantages, some of which are listed here. First, electronic business is accelerated through Web Services (i.e. direct application to application interfaces using SOAP in XML in HTTP). By utilizing the trust assertions of the present invention as an integral component of their Web Services offerings, business partners will be able to interconnect their Web Services very quickly. UDDI and WSDL are two protocols that permit Web Services and their interfaces to be published in a meta-directory, and may allow for “drag and drop” Web Services interface deployment. However, these protocols are currently only used for referencing low-value transactions, due to the lack of trust and contractual assurances. By utilizing the trust assertions of the present invention, UDDI and WSDL could be utilized for high-value Web Services transactions as well. Then, the only remaining barrier for instant-on autonomous Web Services is contract negotiation. Using the present invention, business partners can react very quickly to market changes by rolling out Web Services interfaces to existing and new partners in days instead of months, because the security and interface barriers can be identified within minutes instead of weeks.

Several consortiums and business groups are currently working to create “circles of trust” within industries, to permit Single Sign-on through federated identity management. However, these circles of trust are constrained when they cross industry, country and other trust barriers. If these business trust models use the trust assertions of the present invention to provide a common language and framework for trust modeling, these circles of trust may no longer be constrained to single industries or circles, but can now enable the rapid deployment of cross-industry electronic business.

The most striking effect from implementation of trust governance in accordance with the present invention is in the compliance and assessment functions within organizations. By implementing rapid assessments with the inventive protocol, the tasks of establishing, assessing and governing business trust models becomes an automated process. Further, by moving the trust assessments to the transaction point, compliance with the business trust model is provided automatically and proactively. Trust assertions can easily be forwarded to a central repository, for further compliance analysis.

Through implementation of the inventive trust modeling concepts, compliance organizations can shift compliance and risk management workers from a cost to a revenue basis. Instead of the drudgery of assessing and reporting on risk models, knowledge workers can focus on building and extending trust models. Risk assessments become a key business enabler, rather than a cost sink. Further, the hidden costs of continuous assessments and governance are converted into hard-dollar infrastructure and application costs that can be included in budgets for projects that implement those risks, rather than being borne by the risk management, security and compliance organizations as overhead. The risk posture of partnerships can also be determined and evaluated at the point of project initiation, rather than weeks later. By attaching costs and risks to the projects that generate them, senior management can make more informed decisions on project ROI and Return on Risk.

Although most contracts today include verbiage that permits a periodic or unscheduled on-site visit by one or both parties of the contract, this assessment is rarely executed, due to the high cost of such assessments. However, with the availability of continuous determinations of trust compliance, these components of contract compliance can be verified automatically. If the contracts are structured to require periodic third party assessments and trust assertions, the trust models can be self-regulated through ongoing analysis of the trust assertions.

Through the creation of a common framework and language for discussing standards compliance, the present invention permits translations of assessments across international and industry boundaries. If an assessment was provided against the Common Criteria standard, but the organization has based their policies and trust models on BS7799, the assessment can still be used by the business partners. The relying organization would have to assess the individual answers to all of the questions of the “new” standard, and then determine what their requirements would be within that business context. Once completed, the organization would have a template that can be used to translate Common Critera to BS7799, and this could be extended to other trust models in the organization. The present invention provides a common language for interpreting standards, and permits wide re-use of assessments across many isolated contexts.

Security and privacy regulatory proponents primarily cite the need for regulation to establish and enforce common standards. With industry-wide adoption of the present invention and the underlying standards, regulators can assess the compliance of organizations within their jurisdictional purview without the need to create yet another security standard. Insurers could likewise determine the risk posture of policyholders, and reward strong risk management practices (or punish weak risk management practices) through a tiered pricing structure. By moving industries to a common language for communicating compliance with existing standards, the need to regulate security evaporates. Governing and regulatory bodies are able to provide compliance metrics and oversight without the need to enforce monolithic standards across the industry, and organizations are able to report their security posture without necessarily migrating to yet another security standard.

The power of the present invention as the language of trust governance extends from the ability to make a clear determination of trustworthiness with five simple questions that can be dynamically assessed. The instant payoff from implementation is the ability to determine the trustworthiness of business partners without long checklists and expensive manual processes, and by ensuring that businesses, divisions, and applications are trustworthy at the point that messages and transactions are processed.

It should be understood that various alternatives and modifications of the present invention could be devised by those skilled in the art. Nevertheless, the present invention is intended to embrace all such alternatives, modifications and variances that fall within the scope of the appended claims.

What is claimed is:

1. A method for implementing a risk management program, comprising:
establishing one or more checklist items that measure risk factors and one or more procedures for determining compliance with the checklist items;
wherein trusted parties perform an assessment of each of the entities based on the checklist items using the procedures and, based on the assessment, perform at least one of the following: (i) dispense a machine-readable trust assertion comprising one or more attributes relating to a result of the assessment and (ii) revoke a previously-issued machine-readable trust assertion comprising one or more attributes relating to a result of a previously-performed assessment.

2. The method of claim 1 further comprising:
establishing one or more context factors used in performing the assessment, wherein the context factors comprise at least one of an entity identifier and an entity organizational structure.

3. The method of claim 1 wherein the result of the assessment comprises a trust assertion score associated with the checklist items.

4. The method of claim 2 wherein the result of the assessment comprises a scope of the assessment, determined based on the context factors, wherein the scope of the assessment comprises an identifier for the assessed entity, a portion of the entity included in the assessment, and any portion of the entity excluded from the assessment.

5. The method of claim 1 wherein the checklist items comprise industry-specific checklist items.

6. The method of claim 1 wherein the procedures comprise industry-specific procedures.

7. The method of claim 1, further comprising:
certifying the trusted parties in accordance with a certification process established by a consortium, wherein the consortium performs an assessment of the trusted parties based on the certification process, and, based on the assessment, performs at least one of (i) dispenses a machine-readable trust assertion comprising one or more attributes relating to a result of the assessment and (ii) revokes a previously-issued machine-readable trust assertion comprising one or more attributes relating to a result of a previously-performed assessment.

8. The method of claim 1, wherein the risk factors relate to one or more of security, safety, supply chain, and finances.

9. The method of claim 1 wherein the trust assertion comprises a digital certificate.

10. The method of claim 1 wherein the checklist items are established by a consortium.

11. The method of claim 2 wherein the context factors are established by a consortium.

12. A method for conveying an assessment of an entity, comprising:
receiving from an entity a machine-readable trust assertion issued by a trusted party resulting from an assessment of the entity,
wherein the assessment is based on one or more checklist items that measure risk factors and one or more procedures for determining compliance with the checklist items;
analyzing the trust assertion to determine (1) an identity of the trusted party, (2) checklist items used in the assessment, (3) a score of the assessment, (4) a scope of the assessment; and (5) a date of the assessment;
comparing the identity of the trusted party, the checklist items used in the assessment, the score, the scope and the date to an acceptable trusted party identity, acceptable checklist items, an acceptable score, an acceptable scope and an acceptable date; and
determining, based on the comparison, trustworthiness of the entity.

13. The method of claim 12 wherein the trust assertion comprises a digital certificate comprising one or more attributes relating to the trust assertion.

14. The method of claim 13 further comprising:
analyzing the digital certificate to determine validity.

15. The method of claim 14, wherein the validity determination comprises determining if the digital certificate has been revoked.

16. The method of claim 12, further comprising:
analyzing the trust assertion to determine integrity.

17. The method of claim 14, wherein analyzing the digital certificate comprises analyzing cryptographic components in the digital certificate.

18. The method of claim 12 wherein the identity of the trusted party is embodied in a digital certificate, signed by a consortium asserting that the trusted party is viable and certified by the consortium.

19. The method of claim 18 further comprising:
analyzing the digital certificate of the trusted party to determine if the digital certificate has been revoked.

20. The method of claim 12 wherein the trust assertion score is represented in binary format.

21. The method of claim 20 wherein the trust assertion score is provided in a hexadecimal representation of the binary format.

22. The method of claim 12 wherein the trust assertion score is provided as a sum of binary scores, in base-10 numeral format.

23. The method of claim 12 wherein a consortium establishes one or more context factors used in performing the assessment, wherein the context factors comprise at least one of an entity identifier and an entity organizational structure, and wherein the scope of the assessment is determined based on the context factors and comprises an identifier for the assessed entity, a portion of the entity included in the assessment, and any portion of the entity excluded from the assessment.

24. The method of claim 12 wherein the trust assertion score is represented for at least one of the checklist items to have not been assessed.

25. The method of claim 12 further comprising:
analyzing formatted data associated with the trust assertion.

26. The method of claim 12 wherein the checklist items that measure risk factors and the procedures are established by a consortium.

27. A method for implementing trust governance for an entity, comprising:
generating one or more templates relating to trustworthiness requirements for the entity, based on at least one of an entity policy, any exceptions to the policy and any rules restricting or enabling variances to the policy; and a contractual obligation of the entity;
receiving one or more trust assertions in connection with a trust relationship between two or more entities, wherein the trust assertions are issued by a trusted party resulting from an assessment of one of the entities and comprise components of making a trust decision, comprising one or more of an identity of the trusted party; one or more checklist items that measure risk factors used in the assessment; a score of the assessment; a scope of the assessment; and a date of the assessment;
identifying one or more of the templates to apply to the trust assertion;
comparing the trust assertion to the identified templates; and
determining a result based on the comparison, the result comprising at least one of an acceptance, a rejection and a processing status message.

28. The method of claim 27 wherein the templates are machine-readable.

29. The method of claim 27 wherein the trust assertions are machine-readable.

30. The method of claim 27, further comprising:
performing one or more actions, indicated in the one or more identified templates, associated with at least one of the result and attributes of the assessment.

31. The method of claim 27 wherein one or more of the templates facilitates conversion of a trust assertion of a first type to a trust assertion of a second type.

32. The method of claim 27 wherein the trust relationship relates to one or more transactions.

33. The method of claim 32 wherein the components of making the trust decision further comprise an identity of the transaction.

34. The method of claim 33 wherein the components of making the trust decision further comprise a date of the transaction.

35. The method of claim 27, wherein each of the templates comprise one or more of a portion of the entity covered by the template, and any portion of the entity excluded by the template; checklist items that measure risk factors used by the portion of the entity covered by the template; a score required by the template; an issuer of the template; an issue date of the template; and an expiry date of the template.

36. The method of claim 27, wherein the trust assertion is compared to the identified templates in a specified order.

37. The method of claim 27, wherein the trustworthiness requirements relate to one or more of security, safety, supply chain, and finances.

38. The method of claim 27 wherein the components of making the trust assertion further comprise a date of the determining step.

39. A method for modeling trust relationships, comprising:
collecting one or more trust assertions for an entity, relating to a trust relationship between the entity and one or more other entities, wherein each of the trust assertions is issued by a trusted party resulting from a risk factor assessment of the entity and comprises components of making a trust decision, comprising one or more of an identity of the trusted party; checklist items that measure risk factors used in the assessment; a score of the assessment; a scope of the assessment; and a date of the assessment;
storing the trust assertions;
generating one or more templates relating to trustworthiness requirements for the entity, based on at least one of an entity policy, any exceptions to the policy and any rules restricting or enabling variances to the policy; and a contractual obligation of the entity;
storing the templates;
effectuating a change in at least one of the templates or generating one or more new templates; and
based on a comparison of the stored trust assertions to one or more of (i) the stored templates and (ii) the new templates, determining the impact of the change or the new template on the trust relationship.

40. The method of claim 39 wherein the templates are machine-readable.

41. The method of claim 39 wherein the trust relationship relates to one or more transactions.

42. The method of claim 39, further comprising:
collecting one or more of the trust assertions for one of the other entities; and
storing the trust assertions of the other entity;
wherein determining the impact of the change or the new template on the trust relationship is further based on a comparison of the stored templates to the stored trust assertions of the other entity.

43. The method of claim 41 wherein the components of making the trust decision further comprise an identity of the transaction.

44. The method of claim 43 wherein the components of making the trust decision further comprise a date of the transaction.

45. The method of claim 39 wherein one or more of the templates facilitates conversion of a trust assertion of a first type to a trust assertion of a second type.

46. A method for modeling trust relationships comprising:
collecting one or more trust assertions for one entity relating to a trust relationship with another entity;
storing the trust assertions of the one entity; and
analyzing the trust assertions of the one entity to determine how the trust assertions have changed over time.

47. A method for modeling trust relationships comprising:
collecting one or more trust assertions for at least two first entities relating to a trust relationship with a second entity;
storing the trust assertions of the at least two first entities; and
comparing the trust assertions of at least one of the first entities to at least one other of the first entities.
